(19) United States
(12) Patent Application Publication
(10) Pub. No.: US 2010/0250881 A1
(43) Pub. Date: Sep. 30, 2010

(54) SYSTEMS AND METHOD FOR DATA RECOVERY

(76) Inventor: Joseph Bernard Steffler, Alto, MI (US)

Correspondence Address: JOHN S. BEULICK (12729);C/O ARMSTRONG TEASDALE LLP, 7700 FORSYTH BOULEVARD, SUITE 1800, ST. LOUIS, MO, 63105, US

(21) Appl. No.: 12/415,147

(22) Filed: Mar. 31, 2009

(51) Int. Cl. G06F 12/16

(52) U.S. Cl. 711/162; 711/E12.103

(57) ABSTRACT

Systems and a method for recovering data from a protected memory are provided. The protected memory system includes a memory for storing data related to the operation of a vehicle and an interface configured to transform said data stored in said memory from a proprietary format to an industry standard serial data format.

### BACKGROUND OF THE INVENTION

The field of this invention relates generally to crash protected memories (CPM) and, more particularly, to systems and a method for downloading data stored in a CPM after an off-normal event.

Modern crash recorders are required to record vehicle operation and performance data as well as multiple cabin audio and video sources. With the increasing quantity and bandwidth of data and signal sources, the data bandwidth to and from the CPM portion of the crash recorder continues to increase. Additionally, crash survivability requirements dictate that the number of electrical signal paths in and out of the CPM be kept to a minimum in order to reduce the effects of high-temperature fires often associated with crash events on the electronic devices within the CPM.

Current CPMs utilize proprietary electrical interfaces that use twelve or more conductors. A dedicated data reader for each type of CPM is required to be maintained by investigative agencies to read each of the different types of CPM that may be involved in an off-normal event. Additionally, the number of electrical conductors also conducts excessive heat from a fire often associated with an off-normal event, such as a crash event. The excessive heat is transmitted into the circuitry inside the CPM, which poses a risk to the data stored within.

### BRIEF DESCRIPTION OF THE INVENTION

In one embodiment, a system for recovering data from a protected memory includes a memory for storing data related to the operation of a vehicle and an interface configured to transform said data stored in said memory from a proprietary format to an industry standard serial data format.

In another embodiment, a method for transmitting data from a protected memory system includes coupling a data reader to the protected memory system, receiving data from a memory of the protected memory system, transforming the received data into a format determined by the data reader, and transmitting the transformed data to the data reader.

In yet another embodiment, a flight data recorder includes a data acquisition unit configured to receive a plurality of data signals and to generate a series of data packets for storage and a crash protected memory system including a memory for storing data related to the operation of a vehicle and an interface configured to transform said data stored in said memory from a proprietary format to an industry standard serial data format.

### BRIEF DESCRIPTION OF THE DRAWINGS

FIGS. 1-2 show exemplary embodiments of the systems and method described herein.

FIG. 1 is a schematic block diagram of a flight data recorder in accordance with an exemplary embodiment of the present invention; and

FIG. 2 is a flow chart of a method for transmitting data from a protected memory system in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to systems and a method for downloading data stored on a protected memory in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

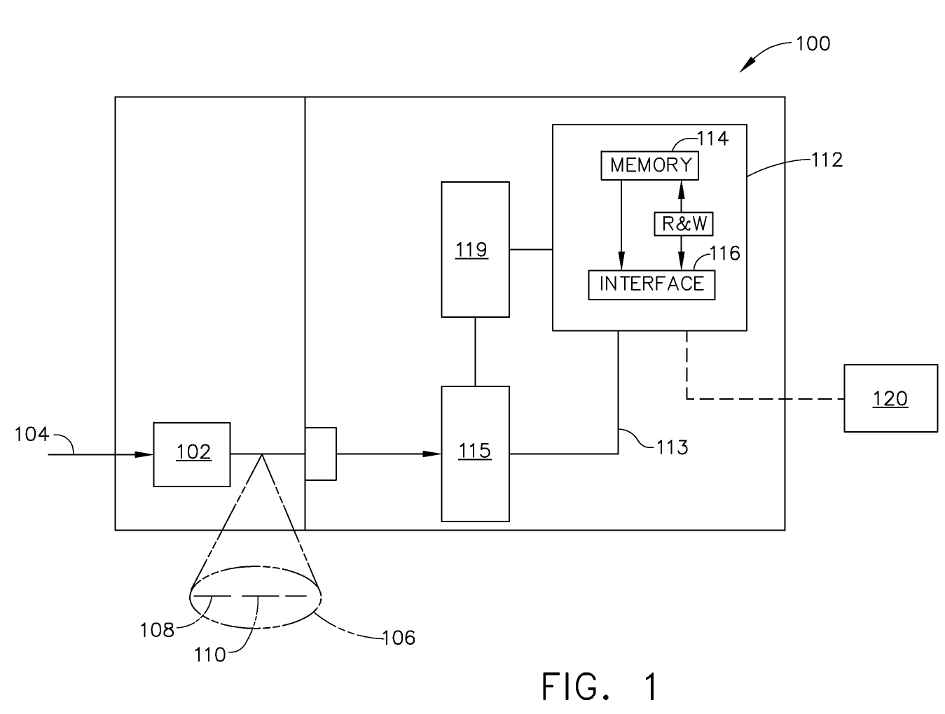

FIG. 1 is a schematic block diagram of a flight data recorder 100 in accordance with an exemplary embodiment of the present invention. In the exemplary embodiment, flight data recorder 100 includes a data acquisition unit 102 configured to receive a plurality of data signals 104 and to generate a series of data packets 106 for storage. Data packets 106 include a data portion 108 and at least one of data packets 106 in the series includes an error-checking portion 110. Flight data recorder 100 includes a crash protected memory (CPM) 112 communicatively coupled to data acquisition unit 102 through a conduit 113 and optionally through an input/output circuit 115. In the exemplary embodiment, CPM 112 includes a memory device 114 that is used to store data related to the operation of a vehicle (not shown). CPM 112 also includes an interface 116 configured to transform data stored in memory from a proprietary format to an industry standard serial data format. As used herein, an industry standard is a standard that describes one or more functional characteristics such as, but not limited to, code conversion, line assignments, or protocol compliance or physical characteristics such as, but not limited to, electrical, mechanical, or optical characteristics necessary to allow the exchange of information between two or more usually different systems or pieces of equipment.

In an embodiment, memory device 114 is configured to store at least one of wideband audio data, narrow band audio data, mixed narrow band audio data, flight data and digital communication message data. Wideband audio data may include audio recorded in for example, a cockpit of the vehicle so that a wide spectrum of sounds from different sources may be recorded. Narrow band audio data from for example, microphones in the cockpit may be recorded to provide accurate recording of critical conversations during an off-normal event.

Interface 116 is configured to transform the stored data into an industry standard serial data format for example, but not limited to, a Power over Ethernet (PoE) format, a Universal Serial Bus (USB) format, an IEEE-1394 FireWire format, and a Serial Advanced Technology Attachment (SATA) format. Additional formats of data transmission protocol may also be used. Interface 116 is further configured to transmit the stored data to a reader 120 using an industry standard serial data format that is a native format of reader 120. Interface 116 is able to detect the native communication protocol of reader 120 and transform the data stored in memory device 114 into the native protocol. In this way, an investigative agency investigating the off-normal event can retrieve the data stored in memory device 114 without having to use a proprietary reader supplied by the manufacturer of flight data recorder 100. In various embodiments, interface 116 is further configured to transmit the stored data to reader 120 wirelessly. During an off-normal event, a fire or a heat event may burn conduit 113 away from CPM 112. In such a case, during a recovery of the data stored in memory device 114, a new pigtail of wires may need to be attached to interface 116 to transmit command signals from reader 120 and receive data from interface 116. Interface 116 includes a plurality of terminations each corresponding to a pinout of a serial data format bus so that interface 116 and reader 120 are able to communicate using any industry standard serial data format.

The unique application of the industry standard serial data and power interfaces such as Power over Ethernet (PoE), Universal Serial Bus (USB), IEEE-1394 FireWire or Serial Advanced Technology Attachment (SATA) enables the required data bandwidth while utilizing only 4 to 6 physical electrical conductors. Current crash protected memories utilize proprietary electrical interfaces requiring twelve or more electrical conductors. These electrical conductors also conduct heat from the fire often associated with an off-normal event, such as a crash event, into the circuitry inside CPM 112, which poses a risk to the data stored within memory device 114. The proprietary electrical interfaces also make investigations more difficult for investigative agencies by requiring that dedicated read-out hardware for every version of crash protected memory in use be maintained.

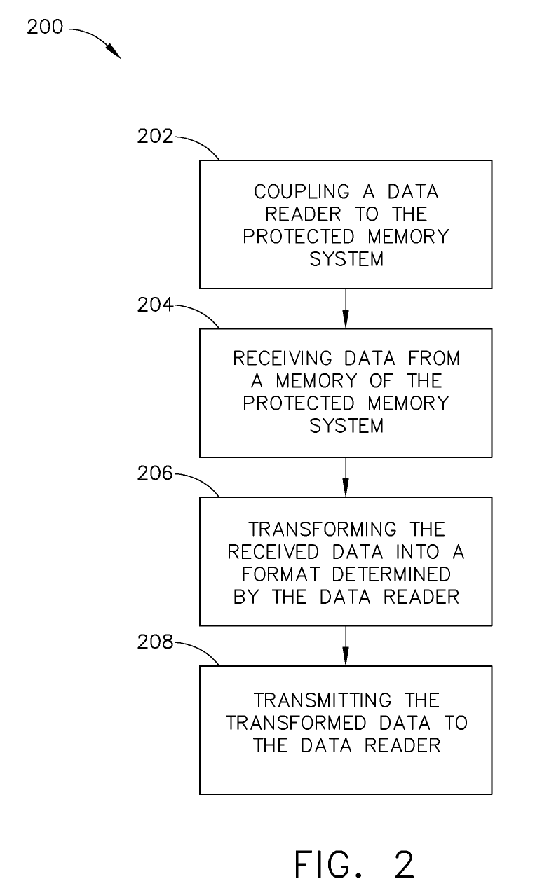

FIG. 2 is a flow chart of a method 200 for transmitting data from a protected memory system in accordance with an exemplary embodiment of the present invention. In the exemplary embodiment, method 200 includes coupling 202 a data reader to the protected memory system and receiving 204 data from a memory of the protected memory system. The received data may be for example, but not limited to, wideband audio, narrow band audio, mixed narrow band audio, flight data and digital communication messages. Method 200 also includes transforming 206 the received data into a format determined by the data reader such as a serial data format, for example, Power over Ethernet (PoE) format, a Universal Serial Bus (USB) format, an IEEE-1394 FireWire format, and a Serial Advanced Technology Attachment (SATA) format, and transmitting 208 the transformed data to the data reader. In the exemplary embodiment, the data reader is coupled to the protected memory system using an industry standard serial data connector. In an alternative embodiment, the data reader is coupled to a connection associated with a predetermined format. In various embodiments, the received data includes a timestamp. The received data may be stored in a compressed state such that the interface may transform the compressed data or may uncompress the data before transmitting the data to the reader.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor 119. Processor 119 may be used in CPM 112 or may be absent depending on the requirements of CPM 112.

As used herein, the term memory may include RAM memory, ROM memory, EPROM memory, EEPROM memory, and non-volatile RAM (NVRAM) memory. The above memory types are exemplary only, and are thus not limiting as to the types of memory usable with flight data recorder 100.

As will be appreciated based on the foregoing specification, the above-described embodiments of the disclosure may be implemented using computer programming or engineering techniques including computer software, firmware, hardware or any combination or subset thereof, wherein the technical effect is the application of electrical and protocol portions of industry standard serial data interfaces to permit the required data bandwidth over a minimum number of electrical conductors and enhancing the supportability of the CPM 112 for the investigation agencies as well as manufacturing and depot support processes. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of systems and a method for transmitting data from a protected memory system provides a cost-effective and reliable means for recovering data from a protected memory system using an industry standard interface. More specifically, the systems and method described herein facilitate reducing a number of proprietary readers an investigative agency needs to recover data from protected memory systems. As a result, the systems and method described herein facilitate recovering data during an off-normal event investigation in a cost-effective and reliable manner.

Exemplary systems and a method for transmitting data from a protected memory system that is subject to harsh environments are described above in detail. The systems illustrated are not limited to the specific embodiments described herein, but rather, components of each may be utilized independently and separately from other components described herein. Each system component can also be used in combination with other system components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A crash protected memory (CPM) system comprising:
a memory for storing data related to the operation of a vehicle; and
an interface configured to transform said data stored in said memory from a proprietary format to an industry standard serial data format.

2. A crash protected memory system in accordance with claim 1 wherein said memory is configured to store at least one of wideband audio data, narrow band audio data, mixed narrow band audio data, flight data and digital communication message data.

3. A crash protected memory system in accordance with claim 1 wherein said interface is further configured to transform the stored data into at least one of a Power over Ethernet (PoE) format, a Universal Serial Bus (USB) format, an IEEE-1394 FireWire format, and a Serial Advanced Technology Attachment (SATA) format.

4. A crash protected memory system in accordance with claim 1 wherein said interface is further configured to transmit the stored data to a reader using an industry standard serial data format.

5. A crash protected memory system in accordance with claim 1 wherein said interface is further configured to transmit the stored data to a reader wirelessly.

6. A crash protected memory system in accordance with claim 1 wherein said interface comprises a plurality of terminations each corresponding to a pinout of a serial data format bus.

7. A method for transmitting data from a protected memory system, said method comprising:
coupling a data reader to the protected memory system;
receiving data from a memory of the protected memory system;
transforming the received data into a format determined by the data reader; and
transmitting the transformed data to the data reader.

8. A method in accordance with claim 7 wherein coupling a data reader to the protected memory system comprises coupling the data reader to the protected memory system using an industry standard serial data connector.

9. A method in accordance with claim 7 wherein coupling a data reader to the protected memory system comprises coupling the data reader to a connection associated with a predetermined format.

10. A method in accordance with claim 7 wherein receiving data from a memory of the protected memory system comprises receiving at least one of wideband audio, narrow band audio, mixed narrow band audio, flight data and digital communication messages.

11. A method in accordance with claim 7 wherein receiving data from a memory of the protected memory system comprises receiving data including a timestamp.

12. A method in accordance with claim 7 wherein transforming the received data comprises transforming the received data into at least one of a Power over Ethernet (PoE) format, a Universal Serial Bus (USB) format, an IEEE-1394 FireWire format, and a Serial Advanced Technology Attachment (SATA) format.

13. A method in accordance with claim 7 wherein transforming the received data comprises transforming the received data into a serial data format.

14. A method in accordance with claim 7 wherein transforming the received data comprises transforming at least a portion of the received data from a compressed state to an uncompressed state.

15. A method in accordance with claim 14 wherein transmitting the transformed data to the data reader transmitting the transformed data in an uncompressed state.

16. A method in accordance with claim 7 wherein transmitting the transformed data to the data reader transmitting the transformed data in a compressed state.

17. A flight data recorder comprising:
a data acquisition unit configured to receive a plurality of data signals and to generate a series of data packets for storage; and
a crash protected memory system comprising:
a memory for storing data related to the operation of a vehicle; and
an interface configured to transform said data stored in said memory from a proprietary format to an industry standard serial data format.

18. A crash protected memory system in accordance with claim 17 wherein said memory is configured to store at least one of wideband audio data, narrow band audio data, mixed narrow band audio data, flight data and digital communication message data.

19. A crash protected memory system in accordance with claim 17 wherein said interface is further configured to transform the stored data into at least one of a Power over Ethernet (PoE) format, a Universal Serial Bus (USB) format, an IEEE-1394 FireWire format, and a Serial Advanced Technology Attachment (SATA) format.

20. A crash protected memory system in accordance with claim 17 wherein said interface is further configured to transmit the stored data to a reader using an industry standard serial data format.
